(19) United States
(12) Patent Application Publication
(10) Pub. No.: US 2023/0060525 A1
(43) Pub. Date: Mar. 2, 2023

(54) Green Elevator System Using Weightless Ropes Traction Concept And Related Applications

(71) Applicant: George Bergman, Toronto (CA)

(72) Inventor: George Bergman, Toronto (CA)

(21) Appl. No.: 17/300,589

(22) Filed: Aug. 27, 2021

(51) Int. Cl. B66B 11/00; B66B 9/00; B66B 11/04; B66B 1/36; B66B 11/08

(52) U.S. Cl. CPC B66B 11/005; B66B 1/36; B66B 9/00; B66B 11/007; B66B 11/08; B66B 11/0453

(57) ABSTRACT

A vertical magnetic frame system 142.a, and 142.b, installed in the elevator hoist way, holding on it the entire weight of the stationary traction rope rizes 120, 124, and 126, 128, for the prefered traction system described herein, and used it to move the self-climbing elevator 100, up, or down in the elevator shaft. Further, the preferred traction system is a novelty, allowing the elevator car 100 to move up by traction gears described in FIG. 2.a, FIG. 7.a, and FIG. 10, and to move down gravitationally described in FIG. 11, and in the process to collect more than 85 percent of gravitational velocity of the descending elevator car 100, turning it ito the electricity for the building using this system

### TECHNICAL FIELD

3. The present invention relates to self-climbing elevators; and to a system of magnetic vertical bars configured to support the weight of the stationary ropes used by the same.

### BACKGROUND OF THE INVENTION

5. Today, the typical movement of elevator cars up or down hoist ways is facilitated by means of traction ropes systems. The rope traction machines of such a system use a large quantity of energy, and a lot of electricity is needed just for moving the ropes to facilitate the car function. The old traction system works well, and has reasonable maintenance cost. However a rope-mounted elevator system has a serious drawback, if it has to be employed for a super-tall building as an express elevator. If the elevator shaft is taller than 400 meters, the weight of the ropes is in excess of 35 tons, and the energy needed to move the elevator car is a high power inefficiency, stressing the electricity bill for the buildings using this system. There are more types of self climbing elevators in service today, like the rack and pinion traction system, and some failed passenger elevators projects trying to use rope climbing as a traction system. There are serious limitations of those systems, like the rack and pinion technology, which is very noisy and slow moving, and as a result is used only as an exterior elevator during building construction. The attempts to use rope self-climbing in passenger elevators failed to be embraced by the vertical transportation industry for very important technical issues, like the weight of their stationary ropes, the system required to secure them in place, the impossibility to control the vibrations, etc. In order to be functional, the conventional rope traction systems are known to have a space to house for example, a machine room, and counterweight system in place. All of those limitations are overcome by this invention.

6. For a long time designers have attempted to address those limitations by proposing a new elevator traction system, and to create a more efficient integrated elevator devices in which the machine-less room, contra-weightless system, and the envision to create back electricity using the gravitational energy induced by the weight of the elevator car in moving down operation, is expected to be a norm for future elevators projects. To date, there is not any design system to be considered as a concept break-throw inovation, and proved to be feasible, and able to lead to a new revolution for the vertical transportation industry.

### DISCLOSURE OF THE INVENTION

8. Is the object of this invention to provide a self-propelled climbing elevator, with a magnetic vertical bars system able to magnetically support on it the entire weight of the stationary rope traction.

9. Another object of this invention is to create a new elevator system in which the traction system to be able to facilitate the elevator projects to be machine-less room contra-weightless, and designed to capture more than 85 percent of gravitational kinetic energy in a descending move of the elevator car.

10. Another scope of this invention is to create a very flexible stationary ropes traction system able to be applied for all types of elevators, like: passenger elevators, commercial elevators, and freight elevators.

11. Another very important scope of this invention is to apply the new traction concept for high speed express elevators employed for super-tall buildings, designed to travel 1000, or 2000 plus meters in one trip, and to accept double deck cars, or multiple elevator cars in the same hoist-way.

12. Another scope of this invention is to employ the new traction concept for modernization of the vertical transportation system in the existing buildings, creating larger elevator cars in the existing elevators hoists-way space, increasing the passengers capacity, and efficiency.

13. According to the present invention the elevator hoist-way (elevator shaft), has at least one pair of magnetic vertical bars attached to the hoist-way walls, and adapted to hold through it’s magnets tile system the stationary traction rope in place. The position, and the number of the magnetic vertical bars in the elevator shaft, depending on the elevator system to be employed. In this aspect the passenger elevators might have only one pair of vertical magnetic bars, positioned in the opposite corners (crossover), or in a mirror in the middle of the elevator hoist-way, etc. The commercials, and industrial elevators might have two pairs of magnetic vertical bars systems, meaning that each corner of the hoist-way is served by one magnetic vertical bar. Some heavy duty elevator projects might have three pairs of magnetic vertical bars positioned in all four corners, and in the mirror of the hoist-way walls, etc. Each vertical magnetic bar, (by the magnet tiles function) will magnetically hold in place (hoist) at least one stationary rope on it. For safety reasons each vertical magnetic bar section will hoist (hold in place) two, or multiple magnetic stationary ropes. Further the stationary rope system will be tensioned on the bottom, and on the top of the elevator hoist-way, preferably by certified rope tension device existing today on the market. The magnetic vertical bars structure frames could be constructed by inexpensive curtain sheets of metal ( or other materials ) sections, bolted directly into the elevator hoist-way walls. For a better vertical alignment, the magnetic vertical bars may employ a desired number of brackets (spacers), bolted directly on the elevator hoist-way walls. The linear vertical magnets tiles (plates) sections will be installed by gluing or screwing them in place, (or the like) on each magnetic vertical bars frame system, which are bolted into the elevator hoist-way walls. Most preferably those said tile magnets will be a permanent magnets system.To save magnets materials, some elevator projects might use a designated vertical space (gaps) between tile magnets installed on each magnetic vertical bars frame holder. This embodiment is applied especially for projects using conventional steel rope traction systems, having very strong magnetic capability. Other elevator projects using less magnetically traction rope systems, like the composite flat ropes, covered in flexible non magnetic shields, the space between the magnet tiles installed on the magnetic vertical bars frames will be smaller, or no vertical space (gaps) between magnets tiles at all, creating a continuous wall of vertical magnets on it’s frame holders. Design engineering team will determine the size of the said magnetic vertical bars, and the magnets sections configuration (sizes, and thickness of them) installed in the elevator hoist-way in order to fit any elevator project.

14. According to the present invention an elevator car is moving vertically (up, or down) in the elevator hoist-way by the use of at least one pair of mechanical interdependent traction sheaves drums system. Each sheave traction drum is envisioned to be rotating with the same speed ratio in an opposite direction by a 1 to 1 ratio gearbox system. All main rope climbing traction systems ready to be described here, are designed to be mounted most preferably on the elevator car roof (top end). Some special projects (like a double deck elevator system employed for super-tall building) might have a double rope climbing machine traction system (double pairs of sheaves traction drums), envisioned to be mounted one on the top end, and another, one on the bottom end of the elevator car. In this case the both rope climbing machine traction ( four traction drums) have to operate synchronized. The sheave drums traction system ( most preferable to be groove to matching with the diameter of the stationary ropes) is designed to engage the stationary ropes by wrap-around them at 360 or 720 degree manners, according to the designated elevator project. The preferred embodiment is referring to a passenger elevator designed to employ the most simple and inexpensive stationary rope climbing traction system. In this aspect a single pair of traction sheave drums is designed to be turned in the opposite direction, and in this way it is allowing the vertical rope climbing movement of the elevator car in it’s hoist-way. This vertical movement is made possible by the operation of the one 1 to 1 ratio gearbox system, ( preferably positioned in the middle length of the dual traction shafts assembly) mounted in between, and mechanically connecting each driving shaft forming a mechanical device named: a dual driving shafts busbar assembly. This is designed to be connected, and to transmit the rotational power to the corresponding sheave drums traction system.This design system, is part of the most simple stationary rope climbing traction disclose here, and is envisioned that said dual driving shafts bus bars assembly, to be rotate in opposite directions by the function of the 1 to 1 gearbox assembly mounted preferably in the middle of the dual driving shafts bus bars assembly length. At each front end of the dual driving shaft busbar assembly is mounted a one corresponding sheave drum traction ( some mentioned special elevator projects might have a one traction sheave drum at each end of the dual busbar traction shafts) . In this embodiment the entire traction system, like the sheaves traction drums, the 1 to 1 ratio gearbox, and it’s dual busbar driving shafts, is designed to be powered by the only one traction motor (mover). The traction motor is designed to transmit it’s rotational mechanical power, to a primary shaft bar assembly, (the 1 to 1 ratio gearbox and it’s driving shaft system), and all the way to the traction drums assembly. For better driving motor thrust, on the dual driving shaft busbar assembly is mounted a planetary gearbox unit. The location of the said planetary gearbox could be mounted inside the traction drums, meaning that there would be one planetary gearbox for each sheave traction drum. There is another design option envisioned to use only a single planetary gearbox (or other similar gear system) mounted directly on the traction motor shaft output. In the first design configuration (a planetary gearbox is mounted inside of each sheave traction drum) the rotational speed of the driving 1 to 1 ratio gearbox, and it’s dual traction busbar shaft drive, has the same rotational speed as the driving motor output. In the second design configuration ( planetary gearbox is connected directly with the output of the driving motor shaft ) the rotational speed of the 1 to 1 ratio gearbox, and it’s dual shafts assembly, will have the same rotational speed ratio (reduced speed 1 to 7) as the traction sheave drums. The mechanical rotation output of the planetary gearbox is envisioned to have a 1 to 7 ratio rotation speed between the motor traction shaft output, and the traction sheave drums. Design team may choose either mechanical configuration to fit any elevator project. Further the traction system is preferable to be electrically powered by a catenary bus bar, and a pantograph-like pick-up power system (or alike possibility), attached to the elevator car. Most preferably the catenary power source (AC or DC) consists of two, or three vertically busbar power supply device rises extended to the length of the elevator hoist-way. The “on board” power system is designed to provide all the necessary electricity power in place, allowing it to feed the traction system, the energy storage device, the command and control panels, etc. In the preferred embodiment the power storage device consists of a supercapacitors system ( or for some projects other power storage devices might be employed). A logical application to use a supercapacitor’s electricity storing device is for super-tall buildings applications designed for express elevator projects. In this way for a short time, a large amount of the electricity is allowed to be released quickly to power the main traction motor (motors), and in this way to permit a super-fast acceleration of the said express elevator, without overloading the domestic power supply of the building. As a result, there is a dual power supply configuration. ( line power supply, combined with the supercapacitor’s electricity storage device). In this design configuration the design engineering teams can create a unique moving elevator algorithm, allowing the said express elevator to be accelerated at super high speed, and allowing the express elevator to travel more than 1000 meters in less than 30 seconds.

15. This new concept of elevator traction system is envisioned not to be just a machine-less room, contra-weightless, but to be the most power saver in today’s vertical transportation industry. By turning the traction motor in reverse, ( elevator is descending by gravity ) in the same time is activated the one way crank bearings system, to permit the one way rotation of the flywheel-governor- generator assembly, (is turning itself one way spin by gravity), and in this way is creating the possibility to put back more than 85 percent of electricity on the building greed by collecting a dual gravitationally kinetic energy. (by collecting the electricity of the traction motor in reverse, and the one-way spin rotation of the flying wheel generator-governor assembly) of the descending elevator car, and to make the new system a very efficient power saver, and allowing it to be connected at a green energy source.

16. In operation the new traction system is designed to facilitate the elevator car to descend gravitationally. In this embodiment, the passenger elevator car described here is designed to be moved down gravitationally. The purpose for this move is to put back into the building grid more than 85 percent of electricity that was used before by the traction system in operation at the time the elevator was ascending. The invented system, in order to be feasible, and practical, on the dual driving shafts busbar assembly, is installed a one way crank bearing system, and monted on it is: the utility brake assembly, the 1to18 ratio speed multiplication gearbox system, designed to turn the flying wheel- generator-governor assembly, and the parking brake system. The traction sheave drums, and the planetary gearbox mounted inside the traction sheave drums, or on the output shaft of the traction motor, are not stationary either way the elevator is ascending or descending. When the elevator car is ascending all the one way crank bearings system is stationary. As a result, all those mechanical components installed on those said one way crank bearings systems, like the 1to18 rotational speed multiplication gearbox system part of the flying wheel-generator-governor assembly, the utility, and the parking brakes, are stationary. When the elevator car is in a descending operation, by the one way crank bearing system, all those mechanical components installed on it, like the 1to18 speed multiplication gearbox of the flying wheel-governor-generator assembly, the utility brakes, and the parking brake becomes active, and start to been rotate by gravity. (all those described devices are designed to rotate one way crank for their entire life) At a descending command, the elevator car is allowed to move from it’s parking position by the operation of the utility brakes, starting with the release of the parking brake. The utility, and the parking brake could be powered by a hydraulic pump, or other certified electromechanical device. As soon as the brakes are released, the elevator car is starting to move down gravitationally, and by the operation of the one way crank bearings system, is driving the 1to18 speed multiplication gearbox, accelerating the flying wheel-governor-generator assembly. This assembly starts a progressive acceleration, and in 2 or 3 seconds is adjusted to reach the nominal constant descending speed. The nominal descending speed is adjustable to fit any elevator project, from a slow moving elevator on low-rise buildings up to a high speed elevator for super-tall towers. The main driving motor is turning into the opposite direction by gravity and in the process is producing electricity. By the gravitational kinetic power the sheave traction drums assembly will rotate in a descending mode, and is able turn the 1 to 7 ratio planetary gearbox, the dual shaft busbar traction assembly, the 1 to 1 gearbox, and the traction motor in reverse with the same 1to 7 speed ratio output as the elevator car was in the ascending move. As a result, the dual shaft traction busbar assembly, and the main motor has the same speed ratio either way, the elevator car is moving up by the utility power, or down, by gravity. In this design configuration there is created a dual electrical power generation, like the electricity produced by the flying wheel-governor-generator assembly, and the electricity created by the main traction motor in reverse. An elevator car operating without contra-weight creates a lot of down speed acceleration to be addressed. This invention solves this problem by introducing a complex device named the analog speed limit governor, part of the 1to18 ratio gearbox flying wheel-governor-generator assembly. To prevent a runaway acceleration of the descending elevator car, for some elevator project, on the dual shaft busbar traction assembly might be introducing a speed control viscosity device ( Kind of torque converter gears ), to create more resistance, and friction as needed to protect the analog speed limit governor. However this kind of brake friction created by using a torque converter is better to be avoided because it generates a large amount of unwanted heat. In this way the elevator car produces as much electricity as possible when the car is descending.

17. A very important component of this embodiment like the said analog speed limit governor is very conveniently installed on the said dual traction shaft busbar assembly, installed on the said one way crank bearings system. The governor body itself, in order to be functional, and able to physically control the descending speed of the elevator car, employs two essential components; The first one is referring to a rotatory flying brakes system, installed on the corresponding one way crank bearing, installed on the dual shaft busbar assembly. The second main component of the governor body is the stator breaks corona device. How do the two said components work together in order to analog monitor the speed of the descending elevator car? A mechanical design answer is to use the high speed rotational inertia of the flying brakes, rotating Inside the stator corona. Those flying brake shoes are springs connected with the shaft of the governor rotor body. In operation, by high speed (1to 18) rotation those flying brake shoes will push themselves upward, and by rotational inertia, will meet, and thutch the stator corona brakes shoes, preventing the runaway acceleration, and to create the desired nominal speed of the descending elevator car. In this way the governor’s flying breaks, physically control the speed of the descending elevator car. The operation of flying breaks shoes, and the stator brake corona is serving a dual purpose: to crate a desire nominal speed of the descending elevator and as a safety device controlling the down speed acceleration in any situation like, the totally lost of the electricity power, together with the all the other safety device using today for vertical transportation industry. In this unique unwanted situation, the elevator car will descend gravitationally only with the nominal speed down to the bottom of the hoist-way. In practice by adjusting the distance between the flying brakes rotor, and the stator corona brakes is created a very versatile nominal descending speed of the elevator car.This described governor is only an analog speed limit device, and is not designed to bring the descending elevator car to complete stop. It’s purpose is to create a nominal desired speed of the descending elevator car, requested by customers.To bring the descending elevator car to a complete stop, and parking, the utility brakes will be activated. In practice adjusting the distance between rotary flaying brakes, and the stator corona created a very versatile analog speed control device of the descending elevator car adopted to fit any elevator project. In order to bring the descending elevator car to a complete stop, to parking position, the utility brakes will be activated. There are not any brakes necessary to stop the ascending elevator car. Just by reducing, or cutting the power supply of the traction motor, the elevator car will stop itself, by the upward contra-gravitational inertia. These and other arrangements and advantages will become obvious to those skilled in the art having appreciated the flexibility and functionality provided by the elevator system according to the present invention.

### BRIEF DESCRIPTION OF THE DRAWINGS

19. FIG. 1 Shows the preferred embodiment of the present invention without the surrounding hoist-way walls, and the elevator car guide rails.

20. FIG. 2.a Shows a more detailed plan view of the preferred embodiment traction system exposing the sheave drums traction arrangement, and it’s related gears system..

FIG. 2 Shows the second embodiment plan view mechanical traction system schematic mechanical design arrangement.

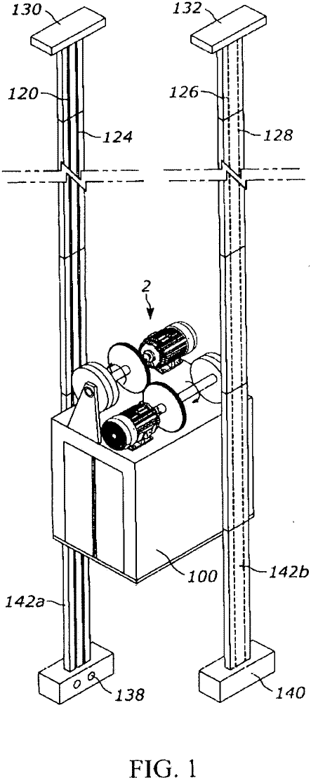

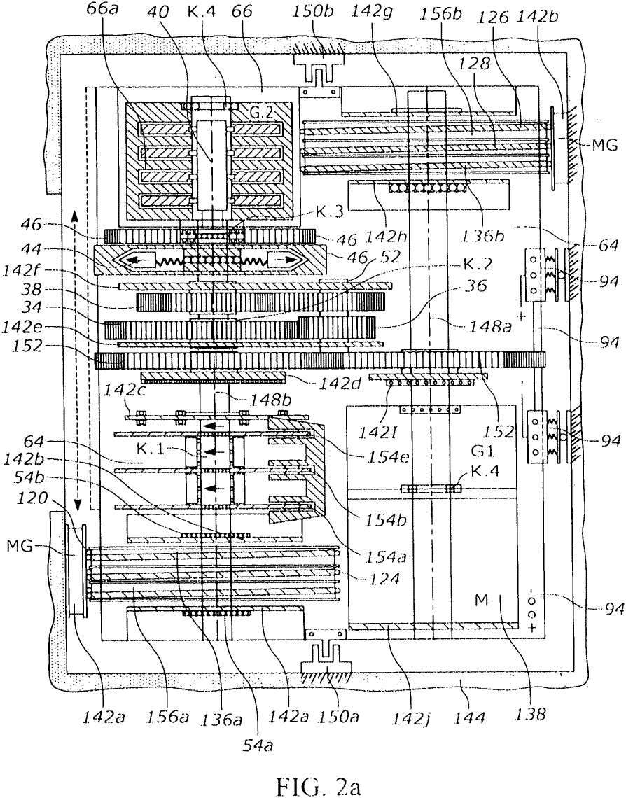

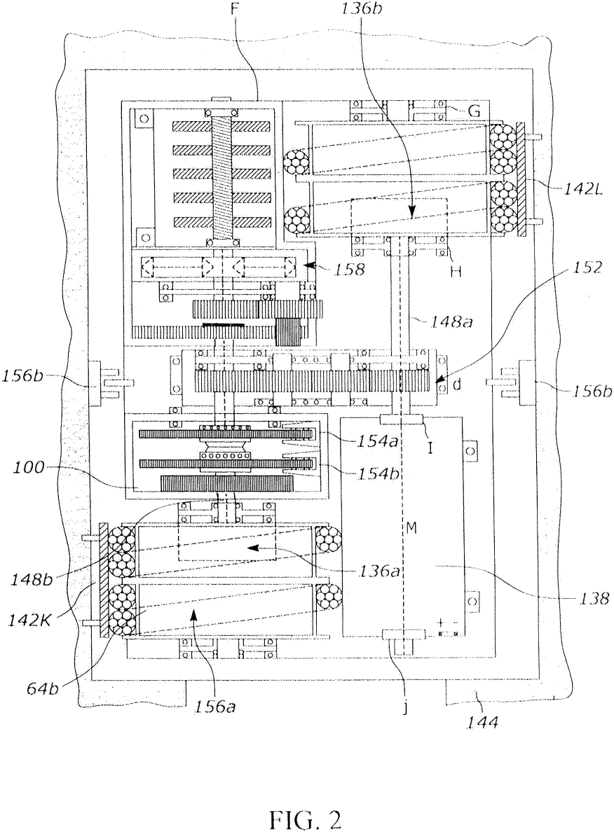

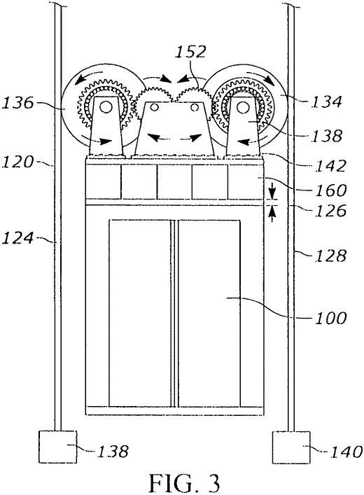

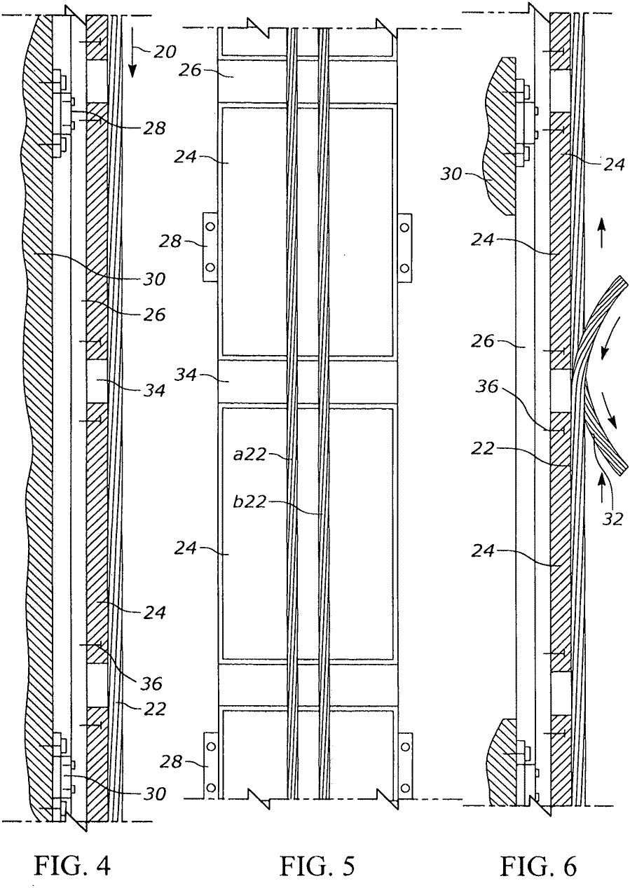

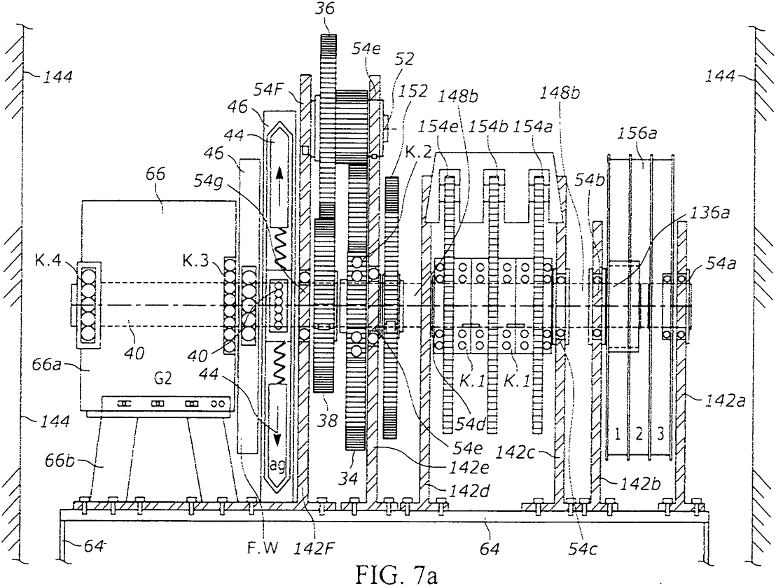

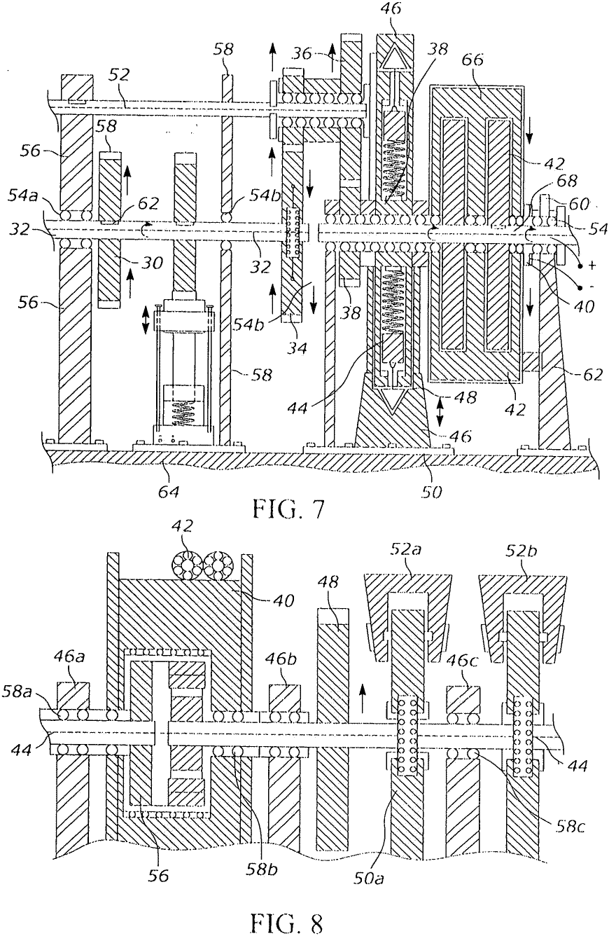

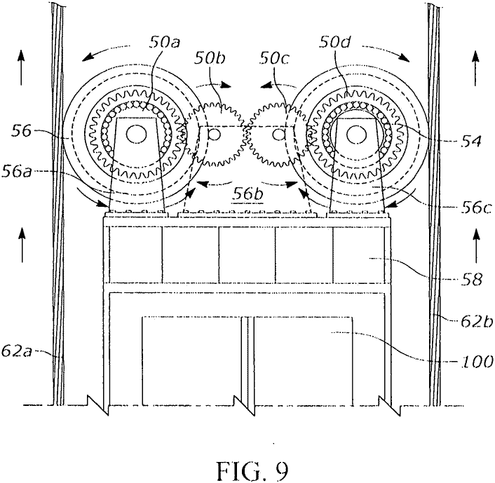

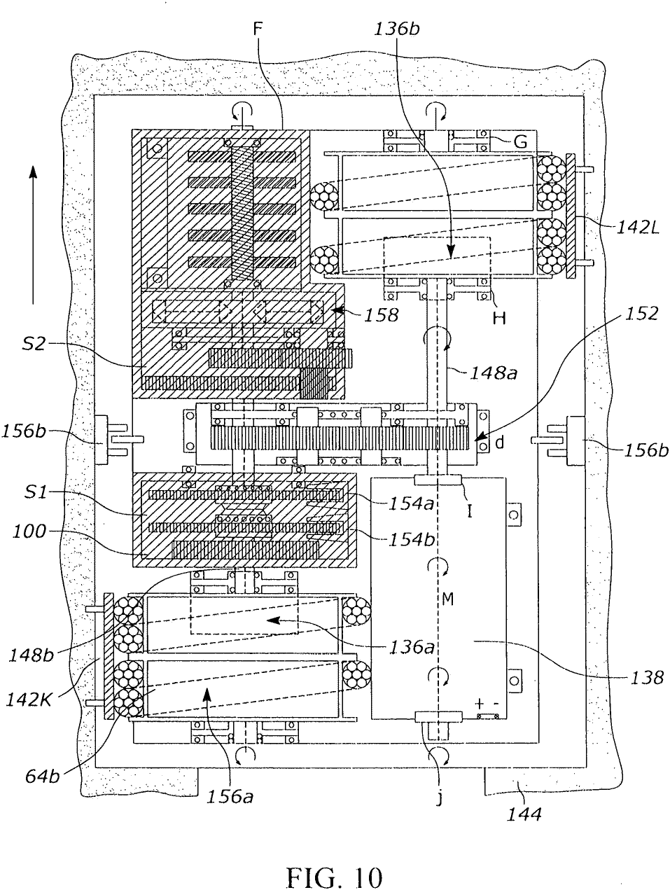

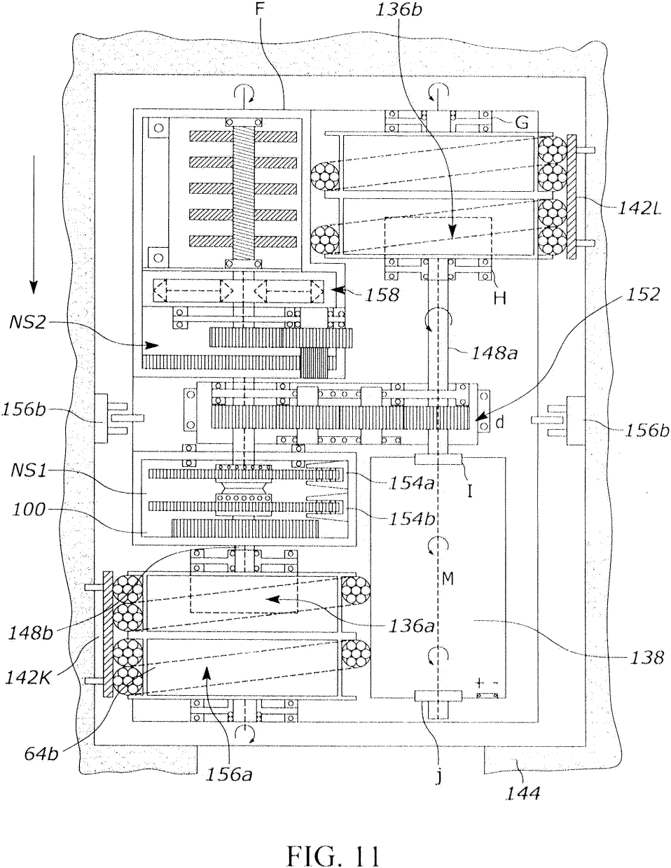

21. FIG. 3 Shows a side elevation of the sheave traction system arrangement, from FIG. 2 and the exposed related mechanical gears system.

22. FIG. 4 Shows a magnified section of the magnetic vertical bars sections, bolted directly into the elevator hoist-way walls shaft.

23. FIG. 5 Shows a front side elevation of the magnetic vertical bars assembly, exposing the stationary ropes arrangement on the magnetic vertical bars frames.

24. FIG. 6 Shows one of the sheave traction drum engaging a stationary rope on the magnetic vertical bar exposed section.

25. FIG. 7.a Shows the sectional side of the preferred embodiment exposing the all mechanical components arrangements installed on the top (roof) of the elevator car.

26. FIG. 7 shows a sectional side of the flying wheel- governor-generator assembly, part of the second embodiment.

27. FIG. 8 Shows a continuation of the side parts, mechanical arrangement from FIG. 7, containing the sheave traction drum assembly, and two utility disc brake assemblies.

28. FIG. 9 Is a schematic side elevation of the traction system installed on top of the elevator car, part of the second embodiment mechanical design arrangement.

29. FIG. 10 Is a schematic representation of the traction system, showing the rotational direction of the traction gears, exposing it’s rotation direction in ascending of the elevator car

30 FIG. 11 Is a schematic representation of the traction system showing the rotational direction of the traction system gears, in a descending of the elevator car. .

### BEST MODE FOR CARRYING OUT OF THE INVENTION

32. Referring now to the drawing figures, and in particular to FIG. 1, a first preferred embodiment according to the present invention will be described in detail. FIG. 1 shows an elevator car 100 positioned within a hoist-way shaft (not showing). A pair of magnetic vertical bars sections 142a-142b, is allowing to have a magnetically capability in order to holds the weight of the stationary ropes, on it’s exposes magnets tile sections, and showing to be able to hold in place the exposed seeing pair of stationary ropes 120-124,and 126-128,. Each pair of ropes are tensioned on the top end of the vertically hoist-way shaft 130-132, and on the bottom end of the vertical hoist-way shaft, 138-140. preferably using conventional certified rope tensioning systems devices. On top (roof) of the elevator car 100, (64) very schematically is showing the arrangement of the main parts of the vertically gears traction system. (Please note, that for the better view, the traction system representation is very schematic in FIG. 1 ,intended to show only the traction motors (movers), and the dual shafts busbars assembly, connected directly with the pair of the traction sheave drums assembly) Referring now to particular FIGS. 2 and 3 enumerate the all parts, and describing the functionality of the preferred embodiment of this invention. An electrical motor 138, is driving the main shaft 148a, part of the dual shaft busbar traction assembly, further is driving the 1 to 1 ratio gearbox contra-rotation assembly, and is defined as the 1 to 1 ratio speed traction gearbox unit 152. ( please note, that the gears system showing in FIG. 2.a, like the 1 to 1 ratio gearbox traction unit, in order to operate, needs only two gears transmission wheels system). In FIG. 2 the embodiment is using the 1 to 1 ratio, gearbox unit transmission system, is employing four gear transmission system assembly, with the same mechanical functionality purpose described in FIG. 2.a), and in this way is connected to the second driving shaft 148b.(part of the same mechanical system defined as the 1 to 1 ratio, dual driving busbar shaft transmission assembly).The gearbox 152 ( two, or four gears 1to1 transmission configuration) is designed to turn the dual driving busbar-shafts assembly in a opposite direction. At the opposite ends of the driving shafts 148a, and 148b, is installed the ropes climbing driving sheaves traction drums assembly 156a and 156b. The connections between each front end shaft, part of the dual busbar-shaft assembly, and the rope climbing sheaves drums system is made by the 1 to 7 rotational speed multiplication, by using a planetary gearbox transmission units,136a, and 136b. In this configuration, the traction motor 138 is rotated 7 times faster than sheaves traction drums, and is creating the necessary power thrust to move the elevator car up. On the busbar- shaft 148.b. is installed a Flying wheel-Governor-Generator assembly, 46. (158, for FIG. 2.), The flying wheel-generator-governor assembly is designed not just to monitor the speed of the car 100, but, it is employed to physically control the speed of the elevator car in any wanted, or unwanted situation. The governor flywheel-generator assembly, 46 is designed to be rotated one way crank, one the bearing, K.3., and is activated only when the elevator car is moving down. Further on the driving shafts 148.b ( part of the dual shafts busbar assembly) is installed a triple disc brake system 154.a,154.b. 154.c. The brake discs assembly is designed to hold one or multiple brake calipers systems ( not showing ). The brake discs 154.a, 154.b.,154.c. are designed to rotate only one way crank on the bearing, K.1. In this configuration when the elevator car is moved up, the utility disc brakes are stationary. The entire traction driving assembly is held in place on top of the elevator car platform by multiple brackets, 142.a to 142.j. Further the elevator car 100 is guided on the elevator hoist-way 144 by a pair of conventionally guided rails rises 150.a, and 150.b. FIG. 3 shows a side elevation of car 100 showing the visible side of the exposed traction components, like the vertically stationary ropes 124-120, down tensioned by the tensioning devices 138, 140. On top (roof) of the elevator car 100 (64) is visible a driving motor (mover) 134, a traction sheave drum 136.a., portion of the 1 to 1 ratio gearbox transmission 152, ( please note that the traction system visible in FIG. 3. is referring to the embodiment in which the transmission of the 1 to 1 gearbox traction is using four gears wheels transmission system to turn in opposite direction the two driving shaft, part of the dual driving busbar shaft assembly ), a brackets assembly 138- 142, and a designated empty space, 160, is envisioned for having a dual practical interest, like to create a phonic isolation, and a storage space device, designed to house the energy storage device, like a battery pack, supercapacitors etc.

33. FIG. 4, FIG. 5, and FIG. 6 described in detail the most important part of this invention, defined as the magnetic vertical bars frames assembly sections. FIG. 4 Shows an elevator (shaft) hoist-way wall 30, and the brackets 28,and 30 bolted into the elevator hoist-way wall. A sheet frame system, metallic or nonmetallic design to be the magnet’s hoist holder 26, is secured in place by the brackets 28, and 30. Further on the magnets vertical bars frame 26 is installed the corresponding magnets tiles (plates) 24 bolted, or glued on the frame 26.The magnets tiles 24 could be installed on the magnetic vertical bars frame without any vertical gapes ( vertical space),( not shown ) on the frame 26, or with a designated vertical gapes, depending of any particular elevator project. FIG. 5 Showed that in this embodiment the magnets tile 24 are installed with a designated vertical gap (vertical spaces) on frame 26. Further on the magnetic vertical frame bars assembly, designed to hold the magnets tile in place, on the face of the said magnets tile, is magnetically held in place the stationary traction ropes 22.a, and 22.b. FIG. 6 Shows the side view of the magnetic vertical bars assembly 20. The stationary traction ropes 22.a, and 22.b ( 22.b not shown ) are engaged by the traction sheave drum 32,( sheave drum not showing, just the stationary rope engagement), and the arrows indicate the direction of engagement. FIG. 7.a. Shows a detailed preferred design of the flying wheel governor-generator assembly, and the associated 1 to 18 ratio gearbox wheels speed multiplication. The governor driving shaft 40 receives the rotation power from the 1 to 1 ratio gearbox wheel 152,( note, for FIG. 7. The 1 to 1 ratio gearbox wheel is notated number 30, part of the 4 wheel transmission gearbox 58, ( not shown ).

Further on the driving shaft 40 is installed a 1 to 18 ( note: the transmission ratio could be adjusted in order to fit any elevator project) speed multiplication ratio gearbox system,(is the driving component of the flying wheel governor-generator assembly unit) constructed by a gearbox assembly consisted by the gear wheel 34, gear 36, and gear 38. The gear 36 is installed on the stationary shaft 52. The driving gear wheel 34 is receiving the rotational thrust from the described dual shaft busbar traction main driving system, and is designed to rotate the speed multiplication gearbox unit ( gear 34, 36, and 38) with the flying wheel governor-generator assembly, rotating on the one way crank on bearing K.2. Gear wheel 34 is receiving it’s thrust rotational power from the gear wheel 36, spinning on the stationary shaft 52. The gear wheel 38 is designed to be the main driving of the 1to18 rotary speed multiplication gearbox system driving the flying wheel governor-generator assembly. and receiving it’s rotational thrust power from the main dual traction busbar assembly driving system. The driving shaft 40, being part of the flying wheel governor-generator assembly unit, is envisioned to be the main shaft rotor of the flying wheel-governor-generator unit. In this configuration the rotor of the generator assembly might be connected with the driving shaft 40, by a coupling device, connecting the said shaft of the generator with it’s rotor driving shaft 40. In some particular design configuration, the driving shaft of the generator is a continuation of the driving shaft 40. To dissipate the rotational kinetic energy, the flying wheel 46, the generator rotor 40, and the analog governor rotor ( part of the high speed 1to18 ratio driving shaft 40) is rotated one way crank on bearing K.3. and K.4. The purpose of this gears design configuration is to prevent the utility brakes system from wearing out when the elevator car is descending, and has the command to stop at any particular floor. In operation after the elevator car stops at any floor, the shaft 40 has to comes to an abrupt stop, but because of the one way crank bearings K.3 and K.4, functioning, the flying wheel 46, the generator rotor 40, and the rotor of the governor-flying wheel generator is still rotating 10, 15 seconds, ( like the bicycle traction wheel gear) dissipating the gravitational rotational kinetic energy, generating electricity, and protecting the utility breaks. This described mechanical component is rotated at a high speed (1to18 ratio) in the same direction with the driving shaft 40. The governor corona stator 46 is installed on the mainframe on top of the elevator car 64.(In FIG. 1 noted elevator 100). Further a system of brackets 142.a to 142.J are designed to secure all the described mechanical devices in place on top of the elevator car 64. ( In FIG. 7 and FIG. 8 the brackets notification is 46.a, 46.b, 56, 58, 62.) The entire gearbox speed rotatory multiplication system, including the flying wheel governor-generator assembly, is designed to be in a stationary position when the elevator car 100 is moved up, or seating in a parking position. The governor system, the flying wheel 46, and generator 66 is activated gravitationally at a descending down command of the elevator car 100 (64), creating electricity. In the second embodiment, FIG. 8 represents a continuation of driving shaft 32 from FIG. 7. On the driving shaft 44 is installed several mechanical assemblies, and is showing a dual one way crank bearings rotating utility disc brake assembly 52.a, and 52.b. In operation the brake discs assembly is stationary, when the elevator car 100 (64) is moving up. The utility brakes become activated when the elevator 100 (64) is moving down, most preferable gravitationally. For further other applications, a gear wheel 48is installed on the driving shaft 44. At the front end of the driving shaft 44 is installed the traction sheave drums assembly 40. In FIG. 7.a, and FIG. 8, the rotational speed of the traction sheave drum 156.a, (156.b not showing) is reduced by 1 to 7 ratio, between the driving motor 138 ( not showing ) and the dual busbar driving shafts assembly 148.a, and 148.b for FIG. 2.a.( for FIG. 8, is a shaft 44.) In FIG. 7, and FIG. 8, the driving shaft 32, is a continuation of the driving shaft 44. Inside the traction sheaves,156.a, and 156.b is a schematic representation of the planetary gearbox system 136.a and 136.b, for FIG. 8 is 56, and a traction drum traction 40.for FIG. 8. In this configuration the reduced speed of the sheave traction drums 156.a and 156.b ( 40 for FIG. 8 ) is translating into high torque (1 to 7 ratio) traction of the said sheave traction drums system, and creating the necessary ascending power needed in order to engage the stationary ropes 42. FIG. 8 ( for FIG. 7.a not showing ). Further the entire mechanical assembly from FIG. 8 is held together by the brackets assembly 46a, 46b, and 46c. All the moving parts drawing in FIGS. 7, and 8, Is served by the appropriate bearing system assembly, like bearings 54a, 54b, 54c, and 54d showing in FIG. 8, and the bearing assembly 58a, 58b, and 58c. showing in FIG. 8. For FIG. 7.a visible are the bearings 54.a,54.b,54.c,54.d,54.e,54.f,and 54.g. All the mechanical components in FIG. 7.a are held together by the brackets assembly 142.a,142.b,142.c, 142.d,142.e142.f,and 66b. FIG. 9 is a magnified representation of the second embodiment described in FIG. 3 The drawing from FIG. 9 shows the rotational direction of the visible mechanical elements, like the traction motor (mover) 54 rotating in the opposite direction with the traction sheave 56, facilitated by the gearbox system 50a, 50b, 50c, and 50d. This mechanical configuration is not limited only for a 1 to 1 rotational transmission ratio, achieved by 4 gearbox wheels assembly system. Some elevators projects might recommended to use only 2 Wheels gearbox transmission assembly (describing in FIG. 2.a, and FIG. 7.a,) to secure the same contra rotational traction of the dual shaft busbar traction system. The arrows direction of the driving traction system showing that the elevator car 100 (64) is moving up, climbing the rope system 62a, and 62b. The mechanical driving system visible in FIG. 9 is held in place by the visible brackets system 54a, 546,and 54c. Visible under the mechanical traction system, is an empty space 58 design to house the power storage devices, and to create a phonic isolation space able to protect the passengers from any noise induced by the traction system in operation

34. FIG. 10 shows a schematic plan view configuration of the traction system pointing to the rotational parts movement when the elevator car 100 (64) is in the moving up operation. In this configuration the driving motor by rotating in the clockwise direction, the primary shaft 148.a will transmit the rotational power to the1 to 1 ratio gearbox assembly 152, and to the planetary gears system 136.b, further turning the traction sheave drums156.b, and 156.a. The breaks discs 154.a, and 154.b are alloyed to stay stationary by the function of the one way crank bearing k.1 ( not showing ). So the driving shafts 148.a, and 148.b is rotated freely, engaging only the sheave traction drums assembly 156.a, and 156.b. Further the main gearbox 152 will rotate the driving shaft 156.a into the opposite direction. The shaft 156.b will turn the planetary gearbox system 136.b of the sheave traction drum 156.b, in the same direction as driving shaft 148.b. Further the driving shaft 148.b will be not turn the one-way crank brakes disc 154.a, 154.b, and the 1 to 18 ratio speed multiplication of the flying wheel-governor-generator gears assembly allowing to stay stationary by the function of the one way crank bearing system K.2, and K.3 ( not showing ). This simple mechanical traction system has low numbers of moving parts, when the elevator car 100 (64) is moving up. In this configuration only the driving motor (mover) 138, the transmission 1to1 gearbox 152, and the sheaves traction drums 156.a, and 156.b, will be rotated engaging the stationary ropes 64.a, and 64.b. The driving motor is powered by the power catenary- pantograph panel assembly 94. The traction system further is served by the necessary bearings system, and the brakes assembly ( not showing), and the entire system is mounted on the platform (mechanical motherboard) 64 on top (roof) of the elevator car.

35. FIG. 11 shows a schematic plan view rotational configuration of the traction system when the elevator car is moving down. In this configuration the elevator car 100 (64) is designed to descend gravitationally. As the car 100 starts to move down, the driving motor 138 is turning in reverse by gravity, producing electricity. Before the elevator car 100 starts to descend the discs breaks system 154.a, and 154.b, slowly (or a snap, abrupt desingagement) will release the pressure of the shoes breaks inside the brake calipers ( not shown ), allowing the car 100 to move down. In the process, the main gear box 152 will turn the driving shaft 148.a into the opposite direction, allowing the one way bearing crank flying wheel-governor-generator gears assembly to become rotating, by gravity, and to activate the high speed ratio multiplication 1to18 speed ratio of the flying wheel gearbox, 34, 36, and 38 assembly. Further the flying wheel 46, and it’s shaft 40 will turn the generator’s rotating shaft with the same speed as the flying wheel 46. (the system is showing in FIG. 2.a). The high speed rotation of the flying wheel-generator-governor assembly 46 will create a desired descending resistance preventing the car from accelerating out of control, and protecting the utility braking system. This movement has a dual practical interest, like the more multiplied the speed in reverse the traction motor, and flying wheel-generator-governor assembly has, the more electricity is produced, and less energy, is needed for the braking system to stop the elevator car. However, descending from the nominal speed, before the car 100 arrives to a full stop at any designated floor, the utility breaks system will act alone to stop the car 100 for bringing it parking position. So for some elevator projects additional breaks system might be needed, or for some projects, a super high speed, and high friction with low heat operation generator device might be employed, to keep functioning until the elevator car arrives at a complete stop. Before bringing the car to a complete stop, the speed control governor-generator assembly will not be able slowing the car 100 to a complete stop, due the low speed of it. As soon as the utility breaks is activated the governor will analog get deactivating itself, due to the low speed of the descending car 100. In conclusion, even though the utility brakes are in use only 3, or 4 seconds at every command stop of the car 100, there could be a lot of wearing of the utility brake shoes, as a result of the weight, and velocity of the car 100 managing not to use any contra weight in operation. So, with today’s advanced technology in a breaking system device ( there are ceramic, and other composite high friction materials with low heat operation might be adapted for any future rope climbing elevator projects.) ,this invention will cover the today high demand for new elevator traction systems adopted to operate at very low energy consuming technology, and able to serve the vertical transportation industry. While the preferred embodiments have been described herein, it is acknowledged that the generally or specific features may vary in part or totally, without departing from the scope of the presently claimed invention.

What is claimed is:

1. An elevator system comprising:
A vertical hoist-way; a stationary traction ropes extending vertically in the hoist-way; an
elevator car disposed within the hoist-way and included a traction system operatively engaging the stationary traction ropes in order to selectively move the elevator car upwards
and downwards along a length of the stationary traction ropes; and at least one pair of magnetic vertical bars affixed in the hoist-way and configured to magnetically engage and support the stationary traction ropes.

2. An elevator system;
according to claim 1, further comprising a dual shaft contra rotational traction busbars adapted to transmit the rotational thrust from one or multiple driving motors (movers), to at
least a pair of contra rotating sheaves drums traction system, adapted to engage said stationary ropes, so said ropes wraps around said traction sheaves drums system in a 360, or 720 degree manners.

3. An elevator system;
according to claim 2, further the traction system comprising an 1 to 1 ratio gearbox system
adapted to rotate the dual driving shafts busbar,assembly, further to a least a pair sheaves traction sheave drums system rotated in a opposite direction, and engaging at least one pair
of stationary ropes in the opposite direction, and further that entire said traction system might be installed on the top end, (roof) or on the bottom end of the elevator car, or on both ends, employing 2 traction systems assembly working synchronized.

4. An elevator system;
according to claim 1, further a plurality of brackets sections bolted into the elevator hoist-way, said brackets attaching the magnetic vertical bars sections into the hoist-way.

5. An elevator system;
according to claim 4, further comprising a permanent magnets tile (plates) system bolted or glued onto magnetic vertical bars support sections, and further said magnets tiles are mounted in line or secvential on said magnetic vertical bars support sections.

6. An elevator system;
according to claim 5, wherein said magnetic tiles are either
permanent or non-permanent magnets system.

7. An elevator system;
according to claim 5, further on the surface of the said magnet tile system is magnetical holding in place one or multiple magnetical stationary traction rops.

8. An elevator system;
according to claim 2,wherein said stationary rops are a steel ropes sectionary round shape.

9. An elevator system;
according to claim 2,wherein said stationary rops are steel or
composite materials flat ropes.

10. An elevator system;
according to claim 1 wherein said magnetic vertical bars sections, are positioned in the opposite corners (cros-over) or in the mirror, in the elevator hoist-way, and further said vertical bars sections designing to support said stationary rope in place is extending through a range of travel in the vertical hois-tway; An elevator car, disposed of within said hoist-way including at least one pair of traction sheave drums, disposed in the opposite corners (cros-over) of the dual traction busbars assembly in the elevator hoist-way. Further a traction sheave drums system is engaging the stationary ropes in the opposite direction facilitating a vertical ropes climbing movement. A traction motor (mover), and a gearbox system adapted to facilitate the traction sheave drums a appropiate power thrust neccessary for vertical movement. A driving dual shaft busbars system housing a one, or multiple driving motors (movers), a 1 to 1 ratio gearbox system design to turn said dual driving shaft assemblyin opposite direction, a flying wheel governor-generator assembly, includingan an analog speed limit inertia rotational brake system, a power supply, a power storage device on board, and a pantograph-catenary power pick-up electrical power on board.

11. An elevator system;
according to claim 10, wherein said traction motor (mover) is electrical feed powered, and it’s rotational thrust power, 1 to 7 ratio, or other multiplication speed ratio, is might been facilitated by a planetary gearbox, or the same systems.

12. An elevator system;
according to claim 11, wherein said mover might be adapted to be a direct drive, and powered by AC, or DC electricity, and it;s rotating speed might be controlled by increase, or decreasing of it;s power supply,
.

13. An elevator system;
according to claim 10, wherein said 1 to 1 ratio gearbox, is a mechanical gear system, or the same, and is facilitating to turn the dual traction busbars system, and the sheave traction drums assembly in the opposite direction.

14. An elevator system;
according to claim 10 wherein said dual shaft busbar assembly is turned by 1 or multiple motors and in the same timme the 1 to 1 ratio gearbox, assembly facilitating to rotate said dual shaft busbar assembly in opposite direction,
and further to transmit the contra-rotating power, to at least one pair of said traction sheave drums assembly, by a rigid 1 to 1 ratio connection between the said dual shaft busbar assembly and the traction sheave drums system, or that said rigid connection might be replaced by a planetary gearbox or the same, to increase the traction power between the traction motor (motors), and the sheave traction drums assembly adapted to engage the stationary ropes.

15. An elevator system;
according to claim 10, wherein said flying wheel-governor-generator assembly is turning at 1 to 18 speed ratio by a gearbox speed multiplication assembly, and further that etire said flying wheel governor-generator assembly is mounted on a one way crank bearings assembly.

16. An elevator system;
according to claim 15, wherein said flying wheel- governor-generator assembly is adjusted to rotate at a different speed multiplication than 1 to 18 ratio, on said one way crank bearing system.

17. An elevator system;
according to claim 10, wherein said flying wheel-governor-generator assembly is turning at 1 to 18 ratio by a gearbox speed multiplication assembly, and further that etire said Flying wheel governor-generator system is mounted on one way crank bearings assembly, allowing that said flying wheel governor-generator assembly to stay stationary when the elevator car is ascending.

18. An elevator system;
according to claim 10, wherein said utility brakes system has one or multiple discs brakes assembly or other brakes means system, and is rotating on a one way crank bearing assembly, allowing that said brakes system to stay stationary when the elevator car is ascending.

19. An elevator system;
according to claim 1, wherein said rope climbing elevator car is moving down gravitationally, and in the process is turning the high speed 1 to 18 ratio flying wheel governor-generator assembly, and at the same time is turning the traction motors (movers) in reverse, with the same rotational ascending speed, and further said traction system is creating a dual assembly electricity producing power,
design for transforming the gravitational car velocity into electricity.

20. An elevator system;
according to claim 10 wherein said power storage device is constituted by a supercapacitors assembly circuit device
.

21. An elevator System;
according to claim 20, wherein said power storage device is constituted by other forms of power storage system.
